(19) United States
(12) Patent Application Publication
(10) Pub. No.: US 2026/0336342 A1
(43) Pub. Date: Oct. 29, 2026

(54) WHEEL SUSPENSION FOR A MOTOR VEHICLE AND CORRESPONDING MOTOR VEHICLE

(71) Applicant: AUDI AG, Ingolstadt (DE)

(72) Inventor: Maximilian REISNER, Weichering (DE)

(73) Assignee: AUDI AG, Ingolstadt (DE)

(21) Appl. No.: 19/113,475

(22) PCT Filed: Oct. 9, 2023
(86) PCT No.: PCT/EP2023/077855

§ 371 Date: Mar. 20, 2025

(30) Foreign Application Priority Data
Nov. 24, 2022 (DE) 102022131074.4

(51) Int. Cl. B60G 3/20

(52) U.S. Cl. CPC B60G 3/20; B60G 2200/156; B60G 2200/18; B60G 2200/44

(57) ABSTRACT

A wheel suspension for a motor vehicle, including a wheel support on which a wheel hub is rotatably supported about a wheel hub rotational axis by a wheel bearing and including two chassis links of a first link assembly, two chassis links of a second link assembly, and a track rod which is hinged to a track rod kinematic point on the wheel support. The chassis links are hinged to the wheel support such that the wheel support describes a rotational movement about a virtual wheel support rotational axis when the track rod is displaced, and a horizontal plane receives the wheel center is aligned horizontally and a vertical plane receives the wheel center and is perpendicular to the horizontal plane delimit multiple orthants from one another. In the installed position of the wheel suspension, the track rod kinematic point is arranged in a first orthant of the orthants.

### FIELD

The invention relates to a wheel suspension for a motor vehicle, comprising a wheel support, on which a wheel hub is rotatably supported or can be rotatably supported about a wheel hub rotational axis by means of a wheel bearing, and comprising two chassis links of an upper link assembly, two chassis links of a lower link assembly, and a track rod which is hinged on the wheel support at a track rod kinematic point, wherein the chassis links are hinged to the wheel support such that the wheel support describes a rotational movement about a virtual wheel support rotational axis when the track rod is displaced, and wherein a horizontally oriented horizontal plane which receives a wheel center and a vertical plane which receives the wheel center and which is perpendicular to the horizontal plane delimit multiple orthants from one another, wherein, in the installed position of the wheel suspension, the track rod kinematic point is arranged in a first orthant of the orthants. The invention further relates to a motor vehicle.

### BACKGROUND

DE 10 2018 206 402 A1, for example, is known from the prior art. The invention relates to a wheel suspension for a motor vehicle, comprising a wheel support, which is rotatably supported about a steering axis for steering the motor vehicle and on which a wheel hub, which carries a rim of a wheel of the motor vehicle, is or can be rotatably supported about a wheel hub rotational axis by means of a wheel bearing and which has a bearing point for connecting a track rod, and comprising a first link assembly and a second link assembly, which engage on the wheel support at a distance from one another in the axial direction with respect to the steering axis for coupling the wheel support to a body of the motor vehicle. In this case, it is provided that, in the installed position of the wheel suspension, a kinematic point of a track rod bearing serving for connecting the track rod to the bearing point is arranged in front of the steering axis in the direction of travel of the motor vehicle and above a horizontal plane which receives or intersects the wheel hub rotational axis and is arranged horizontally.

Furthermore, DE 10 2019 002 655 A1 discloses an axle arrangement for a vehicle, which is characterized by a subframe with a respective wheel support on each side of the subframe, wherein a lower trapezoidal link, an upper camber link and a track rod are arranged behind the wheel support center between the subframe and the respective wheel support, wherein a longitudinal force coupling is arranged between the respective wheel support and the respective trapezoidal link and wherein a spring and a damper act on the respective trapezoidal link.

### SUMMARY

It is an object of the invention to propose a wheel suspension for a motor vehicle which has advantages over known wheel suspensions, is preferably of compact construction, in particular in a longitudinal direction of the motor vehicle. Furthermore, the wheel suspension should preferably be particularly suitable for a motor vehicle designed as an electric motor vehicle.

This is achieved according to the invention with a wheel suspension for a motor vehicle. In this case, it is provided that the wheel support rotational axis extends through a second of the orthants which is opposite the first orthant with respect to the wheel hub rotational axis.

It is pointed out that the embodiments explained in the description are not limiting; rather, any variations of the features disclosed in the description, the claims and the figures can be implemented.

The wheel suspension is preferably part of the motor vehicle, but can of course also be separate from it. It serves to connect the wheel support and thus a wheel of the motor vehicle to a body of the motor vehicle. The wheel suspension is preferably provided and designed for the suspension, in particular for the resilient suspension, of the wheel support with respect to the body. The wheel is rotatably supported or can at least be supported on the wheel support of the wheel suspension. For this purpose, the wheel is attached or can be attached to the wheel hub, which is rotatably supported on the wheel support, for example by means of a wheel bearing. The wheel or at least one rim of the wheel is rotatably supported on the wheel support via the wheel hub. The rim serves as a support for a tire of the wheel, preferably a pneumatic tire

The wheel hub can be a component of the wheel bearing or can be integrated therewith. For this purpose, for example, the wheel hub is designed with an inner ring or an outer ring of the wheel bearing in one piece and/or in a material-uniform manner, whereas the respective other ring, that is to say either the outer ring or the inner ring, is fastened to the wheel support. The wheel support, the wheel bearing and the wheel are not necessarily part of the described wheel suspension, but they can optionally be part thereof.

The wheel support has, for example, a wheel bearing receptacle which is designed as an opening, in particular as an edge-closed opening, in the wheel support. The wheel bearing is located in the wheel bearing receptacle at least in portions. In addition, the wheel hub and/or a shaft coupled to it in a rotationally fixed manner engages at least partially in the wheel bearing receptacle. Particularly preferably, the wheel hub and/or the shaft penetrate, in particular together, the wheel bearing receptacle in the axial direction with respect to the wheel hub rotational axis at least partially, in particular completely.

Via the shaft, the wheel hub is preferably coupled to a drive device at least temporarily in a driving manner. The drive device can be designed as an individual wheel drive. Preferably, it has an electric traction machine by means of which a drive torque for driving the motor vehicle can be generated or is at least temporarily generated.

The wheel bearing is preferably designed as a rolling bearing and therefore has the inner ring and the outer ring, between which rolling elements are present to reduce friction. The inner ring is assigned to the wheel hub, in particular connected to the wheel hub, for example it is designed as a single piece with it or fastened thereto, whereas the outer ring is assigned to the wheel support, in particular connected to the wheel support, for example fastened thereto. The outer ring is preferably located in the wheel bearing receptacle. In other words, the outer ring rests with its outer peripheral surface on an inner peripheral surface of the wheel support that delimits the wheel bearing receptacle.

The wheel support is connected or can be connected to the body via the chassis links. After the wheel suspension has been mounted on the motor vehicle, each of the chassis links thus engages on the one hand on the body and on the other hand on the wheel support, in particular in each case in a pivotably movable manner. The engagement on the body can be implemented directly or only indirectly, for example via an auxiliary frame or chassis. The chassis links are, for example, in the form of transverse links and/or longitudinal links. The chassis links are preferably in the form of two-point links, each of the chassis links in this case therefore being designed as a two-point link.

In the case of the wheel suspension described here, the chassis links are a component of the first link assembly and of the second link assembly, each of the link assemblies having two chassis links. In addition to the chassis links of the two link assemblies, the wheel suspension has the track rod, which ultimately also serves to connect the wheel support to the body.

Each of the chassis links has a first kinematic point and a second kinematic point. Each of the chassis links is hinged to the wheel support via its first kinematic point and to the body via its second kinematic point. The track rod has the track rod kinematic point and is connected to the wheel support via this. The kinematic points are to be understood as meaning centers of rotation of connections of the chassis links and the track rod to the wheel support or the body. Preferably, each of the chassis links and the track rod are hinged to the wheel support or the body by means of a bearing. In the case of the track rod, this bearing can be referred to as a track rod bearing, the bearings of the chassis links can be referred to as a chassis link bearings.

The bearings usually permit both a rotary movement of the chassis link or the track rod about a rotational axis and a tilting movement of the chassis link or the track rod with respect to the wheel support or the body. The rotary movement and the tilting movement take place about the respective kinematic point, which thus represents the center of rotation or a center of rotation of the respective bearing. The kinematic point is preferably located on the rotational axis of the respective bearing. For example, the bearing is in the form of a ball joint or ball pivot joint.

The track rod is coupled to the wheel support at a bearing point of the wheel support. The bearing point is present, for example, on a track lever of the wheel support, which is designed as a projection which starts from a base body of the wheel support or projects beyond the latter. The wheel bearing receptacle is preferably configured in the base body. It can be provided that the wheel support-side track rod bearing is integrated into the track rod. However, it can also be present separately from it. The same applies to the wheel support-side suspension link bearings.

Together with the second kinematic point of the respective chassis link, each of the first kinematic points defines an imaginary straight line which is regarded as the longitudinal center axis of the chassis link. The imaginary straight lines of the suspension links intersect at an intersection for each of the link assemblies. The virtual wheel support rotational axis is defined by the two link assemblies or their chassis links. For example, each of the two link assemblies defines a point of the wheel support rotational axis, so that for the two link assemblies the wheel support rotational axis corresponds to an imaginary straight line through the points defined by the link assemblies. In particular, these points correspond to the above-mentioned intersections, which in this respect lie on the wheel support rotational axis.

The wheel hub rotational axis, also called the expanding axis, is usually skewed in the motor vehicle, but it is essentially oriented in the direction or parallel to the vertical axis of the vehicle in order to permit a compensating movement of the wheel support and thus of the wheel arranged on it. For the corresponding alignment of the wheel support rotational axis, the kinematic points of the chassis links on the wheel support side defining them must lie at different heights with respect to the vertical axis of the vehicle. With respect to these heights, one also speaks of link planes.

The suspension links are part of the link assemblies. In other words, both the first link assembly and the second link assembly each have at least two of the chassis links. The two link assemblies serve for coupling or connecting the wheel support to the body. For this purpose, they each engage on the wheel support on the one hand and can be coupled or are coupled to the body on the other hand. In the present case, the chassis links of the two link assemblies are arranged at different heights. Insofar, the first link assembly or the chassis links assigned to it lie at a first height position and the second link assembly or the chassis links assigned to it lie at a second height position different from the first height position.

For the present wheel suspension, it is assumed that, in the installed position, the first vertical position of the first link assembly lies above the second vertical position of the second link assembly, so that the first link assembly can also be referred to as the upper link assembly and the second link assembly can also be referred to as the lower link assembly. The respectively assigned chassis links can correspondingly also be named as upper chassis links and as lower chassis links. The installation position is to be understood as meaning an arrangement of the wheel suspension on or in the motor vehicle for the intended use of the motor vehicle. In other words, the wheel suspension is present in the installed position on or in the motor vehicle in such a way that normal and intended driving operation of the motor vehicle is possible.

The installation position can be present after an actual mounting of the wheel suspension on or in the motor vehicle. However, the installation position can also describe an arrangement of the wheel suspension in such a way that it is present analogously to an actually installed state. In order to arrange the wheel suspension in the installed position, it is therefore not necessary to actually mount the wheel suspension on or in the motor vehicle, although this can of course be provided.

The chassis links are hinged to at least the wheel support in such a way that the wheel support describes the rotary movement about the wheel support rotational axis if the track rod is displaced. The wheel support can be steerable or non-steerable. In the steerable embodiment, the track rod is coupled to a steering device of the motor vehicle in terms of drive technology on its side facing away from the wheel support. If, on the other hand, the wheel support is not steerable, the track rod is hinged to the body on its side facing away from the wheel support and accordingly cannot be displaced or can be displaced to a limited extent. The displacement of the track rod is therefore to be understood first of all as an imaginary or virtual displacement which, if it were actually present, would bring about the rotary movement of the wheel support.

An imaginary horizontal plane accommodates the center of the wheel and is oriented horizontally. The wheel center is located on the wheel hub rotational axis and is arranged centrally in the axial direction with respect to the latter with respect to the wheel or at least the rim. In this respect, the horizontal plane is to be understood as meaning a horizontal plane which, for example, in the case of an assumed wheel camber of zero, completely accommodates the wheel hub rotational axis or, in the case of a wheel camber other than zero, is intersected by it at least at an intersection point corresponding to the center of the wheel.

The horizontal plane is preferably present, after the wheel suspension has been mounted on or in the motor vehicle, parallel to a ground on which the motor vehicle is arranged. The ground can be in the form of a roadway or a road, for example. To this extent, the horizontal plane is defined by the longitudinal direction of the vehicle and the transverse direction of the motor vehicle after the assembly of the wheel suspension and is perpendicular to a vertical axis of the motor vehicle.

For example, there is an imaginary plane which is perpendicular to the inner circumferential surface of the wheel support bounding the wheel bearing receptacle and intersects the wheel hub rotational axis at an intersection point. Preferably, the imaginary plane is located in the axial direction with respect to a longitudinal central axis of the wheel bearing receptacle centrally in the wheel bearing receptacle, i.e. represents a center plane of the wheel bearing receptacle. The horizontal plane is now parallel to the ground and includes the intersection of the hub rotational axis and the imaginary plane. The imaginary vertical plane is perpendicular to the horizontal plane, which likewise completely includes the rotational axis of the wheel hub or at least intersects it. The above-mentioned vertical axis of the vehicle lies completely in the vertical plane, which is correspondingly perpendicular to the base of the motor vehicle.

The horizontal plane and the vertical plane jointly delimit a plurality of orthants, which are present here in the form of quadrants. Two of the orthants are located above the wheel center, two other orthants are located below the wheel center. At the same time, two of the orthants are located at the front in the direction of travel, i.e. they point to a front of the motor vehicle, whereas two other of the orthants are located at the rear in the direction of travel, i.e. they face a rear of the motor vehicle. The direction of travel is understood to mean a forward direction of travel in which the motor vehicle moves forward.

In this respect, the orthants can be classified as follows: top front, top rear, bottom front and bottom rear. For the purposes of this description, the following nomenclature is used: a first of the orthants is at the top at the front, a second of the orthants is at the bottom at the rear. A third of the orthants is arranged at the top at the rear, a fourth of the orthants is arranged at the bottom at the front. In the clockwise direction when viewed from above in the direction of the wheel hub rotational axis, the order of the orthants is as follows: first orthant, third orthant, second orthant and fourth orthant.

The wheel suspension described here is designed in such a way that, in the installed position of the wheel suspension, the track rod kinematic point at which the track rod is hinged to the wheel support is located in the first orthant, that is to say, in the installed position above the wheel center and in front of the wheel center in the direction of travel. Particularly preferably, the entire track rod is arranged in the first orthant, so that the entire track rod is present above the wheel center in the vertical direction of the vehicle and in front of the wheel center in the longitudinal direction of the vehicle.

In addition, the wheel support rotational axis should run through the second orthant which is opposite the first orthant with respect to the wheel hub rotational axis, i.e. be arranged behind the wheel center in the direction of travel. In other words, the wheel support rotational axis extends below the vertical plane behind the horizontal plane, namely exclusively behind the horizontal plane. Preferably, an intersection of the wheel support rotational axis with the horizontal plane is arranged behind the vertical plane in the direction of travel.

The described wheel suspension is of extremely compact design, in particular in the longitudinal direction of the vehicle. In addition, it allows the use of an electric traction machine in combination with a steerable wheel axle or a steerable wheel. In particular, the traction machine is arranged behind an axle differential in the direction of travel. Furthermore, special and abuse loads acting on the chassis steering are reduced, in particular in comparison with vehicle steering, which are oriented mainly in the transverse direction of the vehicle. A linear course of the track curve over the deflection is also achieved by appropriate alignment of the vehicle links.

A further development of the invention provides that the wheel support rotational axis intersects the horizontal plane at an angle which is at least 75° and at most 105°, at least 80° and at most 100°, at least 85° and at most 95° or approximately or exactly 90°. This means that the vehicle links are arranged and oriented in such a way that the wheel support rotational axis is perpendicular or at least almost perpendicular to the ground or to a road plane. The above-mentioned advantages are thereby realized.

A further development of the invention provides that a wheel center plane receiving the wheel center point is arranged in the axial direction with respect to the wheel hub rotational axis in the center of a wheel which is fastened or can be fastened to the wheel hub, wherein each of the chassis links has a longitudinal center axis intersecting the wheel center plane in the second orthant or in a third of the orthants which is present on the same side of the vertical plane. The center of the wheel lies in the wheel center plane. The wheel center plane is preferably perpendicular to the wheel support rotational axis. In the axial direction, the wheel center plane is arranged centrally with respect to the wheel, i.e. it intersects the wheel in its center. The second orthant has already been explained; it lies below the horizontal plane and behind the vertical plane in the direction of travel. The third orthant lies on the same side of the vertical plane as the second orthant. Correspondingly, it is also located behind the vertical plane in the direction of travel, but above the horizontal plane.

The longitudinal center axis of each chassis link intersects the wheel center plane in the second orthant or in the third orthant. This means that intersections of the longitudinal center axes of the chassis links with the wheel center plane are arranged either in the second orthant, the third orthant or both the second orthant and the third orthant. For example, at least one of the intersections lies in the second orthant and at least another of the intersections lies in the third orthant. Preferably, several of the intersections are located in the second orthant and the third orthant. In particular, the intersections for the chassis links of the first link assembly are arranged in the third orthant and the intersections for the chassis links of the second link assembly are arranged in the second orthant. In other words, the longitudinal center axes intersect the wheel center plane on the one hand of the vertical plane, namely on the side of the vertical plane lying at the rear in the direction of travel. This, too, serves to achieve the advantages already mentioned.

A further development of the invention provides that the chassis links are each hinged to the wheel support via a first kinematic point, the first kinematic points of the chassis links of the first link assembly being present in the first orthant and/or the third orthant, and/or that the first kinematic points of the chassis links of the second link assembly are present in the second orthant and/or a fourth of the orthants arranged on the same side of the horizontal plane. The first kinematic points of the chassis links have already been discussed. The chassis links are directly or indirectly coupled to the body via these. The orthants have been described and their arrangement has already been explained. The fourth orthant is arranged on the same side of the horizontal plane as the second orthant. It lies correspondingly below the horizontal plane and is arranged in front of the vertical plane in the direction of travel.

The first kinematic points of the chassis links of the first link assembly are present either in the first orthant, the third orthant or both in the first orthant and in the third orthant. For example, one of the first kinematic points thus lies in the first orthant and another of the first kinematic points lies in the third orthant. In other words, the first kinematic points of the chassis links of the first link assembly lie above the horizontal plane, i.e. on the side of the horizontal plane facing away from the ground. In the vertical direction of the vehicle they are thus above the wheel center.

In addition or alternatively, the first kinematic points of the chassis links of the second link assembly are located in the second orthant, the fourth orthant or both in the second orthant and in the fourth orthant. For example, one of the first kinematic points is arranged in the second orthant and another of the first kinematic points is arranged in the fourth orthant. In other words, the first kinematic points of the chassis links of the first link assembly lie above the horizontal plane, i.e. on the side of the horizontal plane facing the ground. This means that the first kinematic points are arranged below the wheel center in the vertical direction of the vehicle.

In addition or alternatively, the first kinematic points of the chassis links of the first link assembly are above the track rod kinematic point or above the entire track rod in the vertical direction of the vehicle. In addition or alternatively, the first kinematic points of the chassis links of the second link assembly lie beneath the track rod kinematic point preferably beneath the entire track rod in the vertical direction of the vehicle. In this respect, it can be provided that the first kinematic points of the chassis links of the first link assembly and the first kinematic points of the chassis links of the second link assembly are arranged in the vertical direction of the vehicle on opposite sides of an imaginary plane which extends through the track rod kinematic point and is oriented parallel to the horizontal plane. The described embodiment also serves to achieve the mentioned advantages.

According to a further development of the invention, the chassis links are or can be hinged via a second kinematic point to a body or to an auxiliary frame connected or connectable to the body, wherein the second kinematic points of the chassis links of the first link assembly are present in the first orthant and/or the third orthant and/or the second kinematic points of the chassis links of the second link assembly are present in the second orthant and/or the fourth orthant. The chassis links are thus hinged to the body or the auxiliary frame via the second kinematic points. The auxiliary frame is an element of the motor vehicle which is separate from the body and which is in turn hinged or fastened to the body. The auxiliary frame serves to stiffen the body. By means of the auxiliary frame, forces acting between the second kinematic points and acting on the auxiliary frame via the chassis links are at least partially compensated before they are introduced into the body.

The second kinematic points of the chassis links of the first link assembly are present either in the first orthant, the third orthant or both in the first orthant and in the third orthant. In the latter case, for example, at least one of the second kinematic points is located in the first orthant and at least one other of the second kinematic points is located in the third orthant. In other words, the second kinematic points of the chassis links of the first link assembly lie in the vertical direction of the vehicle above the wheel center or on the side of the horizontal plane facing away from the ground.

In addition or alternatively, the second kinematic points of the chassis links of the second link assembly are located in the first orthant, the fourth orthant or both in the second orthant and in the fourth orthant. In the latter case, at least one of the second kinematic points is arranged in the second orthant and at least another of the second kinematic points is arranged in the fourth orthant. In other words, the second kinematic points of the chassis links of the second link assembly lie in the vertical direction of the vehicle beneath the wheel center or on the side of the horizontal plane facing the ground. This also achieves the object of providing a particularly compact wheel suspension.

A further development of the invention provides that a first of the chassis links of the first link assembly and a first of the chassis links of the second link assembly are arranged in such a way that their second kinematic points are arranged in the first orthant and/or the fourth orthant, and/or that a second of the chassis links of the first link assembly and a second of the chassis links of the second link assembly are arranged in such a way that their second kinematic points are arranged in the second orthant and/or the third orthant.

This means that the second kinematic points of the two first links are present in the first orthant, in the fourth orthant or both in the first orthant and in the fourth orthant. In the latter case, for example, the second kinematic point of at least one of the first chassis links lies in the first orthant and the second kinematic point of at least one other of the first chassis links lies in the fourth orthant. In other words, the second kinematic points of the two first chassis links lie in front of the vertical plane in the direction of travel of the motor vehicle, that is to say on the side of the vertical plane facing the front side of the motor vehicle.

In addition or alternatively, the second kinematic points of the two second suspension links are arranged in the second orthant, the third orthant or both in the second orthant and in the third orthant. In the latter case, the second kinematic point of at least one of the second chassis links is arranged in the second orthant and the second kinematic point of at least another of the second chassis links is arranged in the third orthant. In other words, the second kinematic points of the second chassis links lie behind the vertical plane in the direction of travel, as on a side of the vertical plane facing the rear of the motor vehicle. Such a design of the wheel suspension also achieves the objectives described at the outset.

A further development of the invention provides that the chassis links intersect the vertical plane in each case at an sweep angle, wherein a mean sweep angle of the chassis links of the first link assembly and a mean sweep angle of the chassis links of the second link assembly have different signs. The sweep angle is the orientation of the chassis links in the longitudinal direction of the vehicle. The sweep angle is therefore to be understood as the angle at which the chassis links or their respective longitudinal center axis intersect the vertical plane, namely as seen in plan view of the horizontal plane. The respective sweep angle is thus determined in an imaginary plane which is parallel to the horizontal plane and lies at the intersection of the longitudinal central axis of the former chassis link and the vertical plane.

From the sweep angles of the chassis links of the first link assembly, the mean sweep angle of the first link assembly is obtained by averaging, and from the mean sweep angles of the chassis links of the second link assembly, the mean sweep angle of the second link assembly is obtained by averaging. The mean sweep angle corresponds in each case to an angle at which an imaginary straight line intersects the vertical plane, viewed in plan view, the imaginary straight line describing an angle bisector of the respective chassis links or their longitudinal center axes.

The mean sweep angles have different signs. This means that the chassis links of the first link assembly, on the one hand, and the chassis links of the second link assembly, on the other hand, are inclined in different directions with respect to the vertical plane, viewed on average in the longitudinal direction of the vehicle. An imaginary first straight line located in a plan view between the longitudinal central axes of the chassis links of the first link assembly and an imaginary second straight line located in a plan view centrally between the longitudinal central axes of the chassis links of the second link assembly are inclined in this respect in different directions with respect to the vertical plane, namely again seen in a plan view. For example, in a direction extending from the wheel support device of the second kinematic points in the direction of travel, the first straight line is further forward than the second imaginary straight line. Once again, the above-mentioned advantages are achieved.

A further development of the invention provides that at least one of the sweep angles is at least 10° and at most 40°. At least one of the sweep angles, but preferably several of the sweep angles, particularly preferably all the sweep angles, lie to this extent—in terms of magnitude between 10° and 40°, these values in each case included. Once again, this serves to achieve the advantages mentioned.

A further development of the invention provides that the track rod has on its side facing away from the track rod kinematic point a further track rod kinematic point which has a distance from the vertical plane which is at least 80% and at most 120% of a distance between the vertical plane and the second kinematic point of the first chassis link of the second link assembly. The further track rod kinematic point is located on the side of the track rod facing away from the wheel support. The track rod kinematic point can also be designated as the first track rod kinematic point and the further track rod kinematic point as the second track rod kinematic point.

Viewed in the longitudinal direction of the vehicle, therefore, the further track rod kinematic point and the second kinematic point of the first chassis link of the second link assembly lie exactly or at least approximately at the same height. The distance of the further track rod kinematic point from the vertical plane is in this respect between 80% and 120% (including these values in each case) of that distance which is present between the vertical plane and the second kinematic point of the corresponding chassis link. In this way, too, the mentioned advantages can be achieved in a simple manner.

A further development of the invention provides that a distance between the kinematic points of the first chassis link of the first link assembly and/or a distance between the track rod kinematic points of the track rod amounts to at least 50% and/or at most 75% of the distance between the kinematic points of the second chassis link of the first link assembly and/or of the distance between the kinematic points of the second chassis link of the second link assembly. The distance between the kinematic points of the chassis links corresponds to their respective length, the distance between the track rod kinematic points corresponds to the length of the track rod.

The length of the first suspension link of the first link assembly and/or the length of the track rod amounts to at least 50% of the length of the second suspension link of the first link assembly or of the length of the second suspension link of the second link assembly. The length of the first suspension link of the first link assembly and/or the length of the track rod amounts to at least 75% of the length of the second suspension link of the first link assembly or of the length of the second suspension link of the second link assembly. This, too, serves to achieve the advantages mentioned at the outset.

A further development of the invention provides that the first kinematic point of the first chassis link of the first link assembly and/or the first kinematic point of the first chassis link of the second link assembly have a distance from the vertical plane which is smaller than a distance of the first kinematic point of the second chassis link of the first link assembly from the vertical plane and/or as a distance of the first kinematic point of the second chassis link of the second link assembly from the vertical plane. In other words, the first kinematic point of the first chassis link of the first link assembly or the first kinematic point of the first chassis link of the second link assembly is closer to the vertical plane than the first kinematic point of the second chassis link of the first link assembly or the second chassis link of the second link assembly.

For example, the vertical plane intersects or is at least very close to the first kinematic point of the first chassis link of the first link assembly and/or the first kinematic point of the first link of the second link assembly. The first kinematic point of the second chassis link of the first link assembly and/or the first kinematic point of the second chassis link of the second link assembly, on the other hand, are further away from the vertical plane. For example, the distance of the first kinematic point of the first chassis link of the first link assembly and/or the distance of the first kinematic point of the first chassis link of the second link assembly is at most 30%, at most 20% or at most 10% of the distance of the first kinematic point of the second chassis link of the first link assembly and/or of the distance of the first kinematic point of the second chassis link of the second link assembly. Again, the mentioned advantages are thus achieved.

A further development of the invention provides that the first kinematic point of the second chassis link of the first link assembly and/or the first kinematic point of the second chassis link of the second link assembly lie in the second orthant and/or the third orthant. The two first kinematic points thus lie, for example, in the second orthant, the third orthant or both in the second orthant and in the third orthant. In particular, one of the first kinematic points is located in the second orthant and another of the first kinematic points is located in the third orthant. This finally means that at least one of the first kinematic points, preferably both first kinematic points, are arranged above the horizontal plane, i.e. on its side facing away from the ground. Once again, the mentioned advantages are thus achieved.

A further development of the invention provides that a coupling rod is hinged on the one hand to the wheel support at a first coupling rod kinematic point and on the other hand to a stabilizer or one of the chassis links at a second coupling rod kinematic point. In addition to the chassis links and the track rod, the wheel suspension therefore has the coupling rod. The coupling rod connects the wheel support to the stabilizer or the chassis link. For this purpose, the coupling rod is hinged at its first coupling rod kinematic point to the wheel support and at its second coupling rod kinematic point either to a stabilizer or to the chassis link. With the aid of the coupling rod, a degree of freedom of the wheel support is eliminated, so that reliable guidance of the wheel support in the vertical direction of the vehicle is ensured.

A further development of the invention provides for a wheel spring and/or a wheel damper to be hinged to the second chassis link of the second link assembly. The wheel spring and the wheel damper can be separate from one another or they are designed as a spring-damper unit. In any case, the wheel spring, the wheel damper or both engage on the second chassis link of the second link assembly or are hinged to the latter. For this purpose, they are particularly preferably arranged between the chassis links of the first link assembly or extend between them in the direction of the second chassis link of the second link assembly. This, too, serves to achieve the already mentioned advantages.

The invention also relates to a motor vehicle having a wheel suspension, in particular a wheel suspension according to the description, wherein the wheel suspension comprises a wheel support, on which a wheel hub is rotatably supported or can be rotatably supported about a wheel hub rotational axis by means of a wheel bearing, and comprising two chassis links of an upper link assembly, two chassis links of a lower link assembly, and a track rod which is hinged to the wheel support at a track rod kinematic point, wherein the chassis links are hinged to the wheel support such that the wheel support describes a rotational movement about a virtual wheel support rotational axis when the track rod is displaced, and wherein a horizontally oriented horizontal plane which receives a wheel center and a vertical plane which receives the wheel center and which is perpendicular to the horizontal plane delimit multiple orthants from one another, wherein, in the installed position of the wheel suspension, the track rod kinematic point is arranged in a first orthant of the orthants. In this case, it is provided that the wheel support rotational axis extends through a second of the orthants which is opposite the first orthant with respect to the wheel hub rotational axis.

The advantages of such an embodiment of the motor vehicle or of the wheel suspension have already been discussed. Both the motor vehicle and the wheel suspension can be further developed according to the embodiments in the scope of this description, to which reference will therefore be made.

The features and feature combinations described in the description, in particular the features and feature combinations described below in the description of the figures and/or shown in the figures may be used not only in the respective specified combination, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURES

In the following, the invention will be explained in greater detail with reference to the exemplary embodiments shown in the drawings, without this limiting the invention. In particular:

FIG. 1 is a schematic isometric representation of a wheel suspension for a motor vehicle,

FIG. 2 is a schematic side view of the wheel suspension,

FIG. 3 is a further schematic representation of the wheel suspension,

FIG. 4 is a schematic plan view of the wheel suspension in a first view,

FIG. 5 is a schematic plan view of the wheel suspension in a second view, and

FIG. 6 is a schematic side view of the wheel suspension.

### DETAILED DESCRIPTION

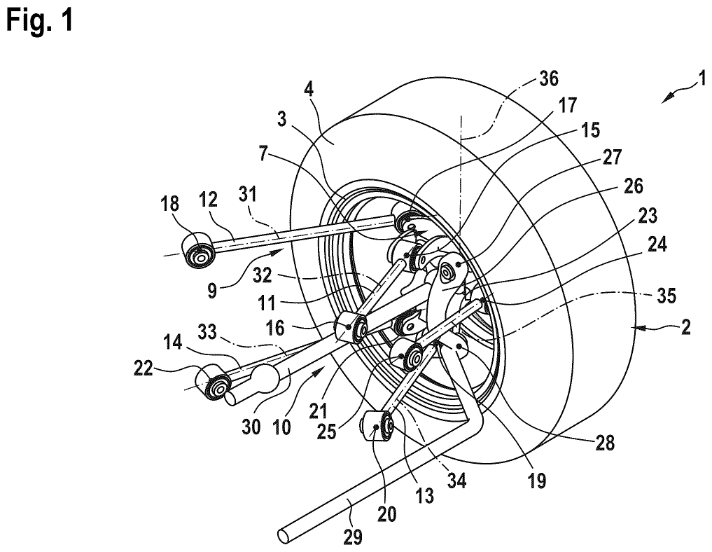

FIG. 1 shows a schematic isometric representation of a wheel suspension 1 for a motor vehicle, not shown in detail. The wheel suspension 1 serves for the suspension of a wheel 2 on a body of the motor vehicle, not shown. In the embodiment shown here, the wheel 2 has a rim 3 and a tire 4, the latter being an air-filled tire. The wheel 2, in particular the rim 3, is fastened, in particular detachably fastened, to a wheel hub 5. The wheel hub 5, which cannot be seen here, is mounted rotatably about a wheel hub rotational axis 8 on a wheel support 7 by means of a wheel bearing 6, which is also not shown.

The wheel support 7 in turn is mounted on the body of the motor vehicle by means of a first link assembly 9 and a second link assembly 10. The first link assembly 9 has a first chassis link 11 and a second chassis link 12. The second link assembly 10 has a first chassis link 13 and a second chassis link 14. The first chassis link 11 has a first kinematic point 15 and a second kinematic point 16, the second chassis link 12 has a first kinematic point 17 and a second kinematic point 18. The first chassis link 13 of the second link assembly 10 has a first kinematic point 19 and a second kinematic point 20, and the second chassis link 14 has a first kinematic point 21 and a second kinematic point 22. The chassis links 11, 12, 13 and 14 are hinged to the wheel support 7 via the first kinematic points 15, 17, 19 and 21 and to the body via their second kinematic points 16, 18, 20 and 22.

In addition to the chassis links 11, 12, 13 and 14, the wheel suspension 1 has a track rod 23 which is hinged at a first track rod kinematic point 24 to the wheel support 7 and at a second track rod kinematic point 25 to the body or a steering device of the motor vehicle. Furthermore, there is a coupling rod 26 which is hinged at a first coupling rod kinematic point 27 to the wheel support 7 and at a second coupling rod kinematic point 28 to a stabilizer 29. In the illustrated exemplary embodiment, the wheel 2 is in the form of a drivable wheel, and the wheel hub 5 is correspondingly coupled to a drive shaft 30 in a drivable manner. However, this can also be omitted, in which case the wheel 2 is not a driven wheel.

The kinematic points 15 and 16, 17 and 18, 19 and 20, 21 and 22 as well as 24 and 25 each define a longitudinal central axis 31, 33, 33, 34 and 35 of the respective chassis link 11, 12, 13 and 14 and of the track rod 23, respectively. The wheel support 7 is hinged to the body by means of the two link assemblies 9 and 10 and the track rod 23 in such a way that it rotates about a virtual wheel support rotational axis 36 (here only indicated extremely schematically) in the event of a (virtual) displacement of the track rod 23. Thus, for example, an infinitesimally small displacement of the track rod 23, in particular in the direction of its longitudinal center axis 35, leads to an infinitesimally small rotational movement of the wheel support 7 about the wheel support rotational axis 36.

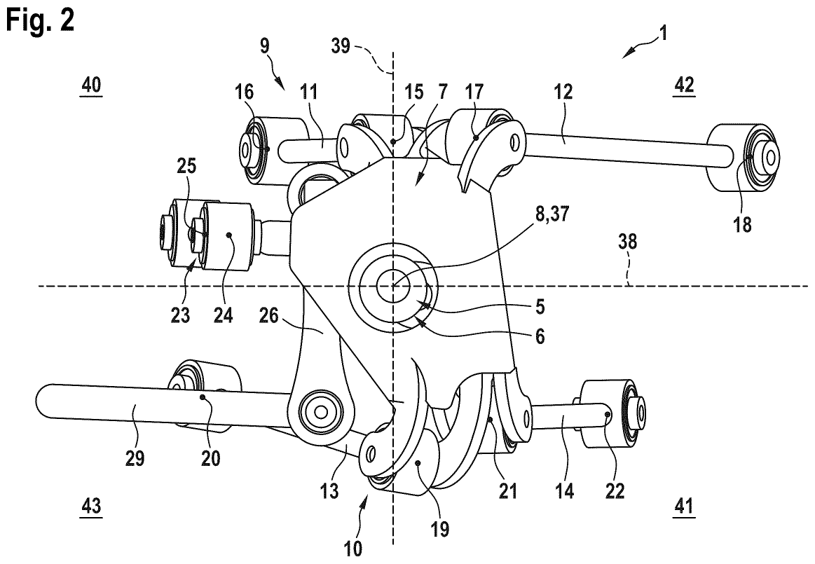

FIG. 2 shows a schematic side view of the wheel suspension 1, the wheel 2 not being shown. However, a wheel center 37 can be seen which is located on the wheel hub rotational axis 8 and is located in the axial direction with respect to the wheel hub rotational axis 8 centrally with respect to the wheel 2. A horizontal plane 38 and a vertical plane 39 extend through the wheel center 37. The horizontal plane 38 is arranged horizontally with respect to a ground or roadway on which the motor vehicle is located as intended, the vertical plane 39 being perpendicular to the horizontal plane 38. Both include the wheel center point 37 so that the wheel center point 37 lies on an imaginary intersecting straight line of the horizontal plane 38 and the vertical plane 39.

The vertical plane 39, when the wheel suspension 1 is arranged as intended, is arranged perpendicular to the ground and, to this extent, is aligned parallel to a gravity vector describing the gravity acting on the wheel suspension 1. The horizontal plane 38 and the vertical plane 39 separate a first orthant 40, a second orthant 41, a third orthant 42 and a fourth orthant 43 from one another. The first orthant 40 and the second orthant 41 are opposite each other in mirror-image fashion with respect to the wheel hub rotational axis 8 and the wheel center point 37, respectively. This also applies to the third orthant 42 and the fourth orthant 43.

It follows that the first orthant 40 and the third orthant 42 are arranged above the horizontal plane 38 and the second orthant 41 and the fourth orthant 43 are arranged below the horizontal plane 38. In addition, the first orthant 40 and the fourth orthant 43 are arranged in front of the vertical plane 39 in the direction of travel of the motor vehicle, and the second orthant 41 and the third orthant 42 are arranged behind the vertical plane 39 in the direction of travel. In other words, viewed in the direction of a longitudinal axis of the vehicle and a vertical axis of the vehicle, the first orthant 40 is located at the top front, the second orthant 41 at the bottom rear, the third orthant 42 at the top rear and the fourth orthant 43 at the bottom front.

The wheel suspension is designed in such a way that the first track rod kinematic point 24 is arranged in the first orthant 40. Furthermore, the first kinematic points 15 and 17 of the chassis links 11 and 12 of the first link assembly 9 are arranged above the horizontal plane 8 and thus in the first orthant 40 and the third orthant 42. Furthermore, the first kinematic points 19 and 21 of the chassis links 13 and 14 of the second link assembly 10 are preferably arranged below the horizontal plane 38, i.e. they are located in the second orthant 41 and the fourth orthant 43. The second kinematic points 16 and 18 of the chassis links 11 and 12 of the first link assembly 9 are likewise arranged above the horizontal plane 38, i.e. they are located in the first orthant 40 and the third orthant 42. The second kinematic points 20 and 22 of the chassis links 13 and 14 of the second link assembly 10 are located below the horizontal plane 38 and thus lie in the second orthant 41 and the fourth orthant 43.

The second kinematic points 16 and 20 of the chassis links 11 and 13 are arranged in front of the vertical plane 39 in the direction of travel, i.e. in the first orthant 40 and the fourth orthant 43. The second kinematic points 18 and 22 of the chassis links 12 and 14 are arranged in the direction of travel behind the vertical plane 39, i.e. in the second orthant 41 and the third orthant 42. It can also be seen that the second kinematic point 20 of the first chassis link 13 of the second link assembly 10 is just as far away from the vertical plane as the second track rod kinematic point 25. However, the distance is at least similar, for example the distance of the track rod kinematic point 25 is at least 80% and at most 120% of the distance of the kinematic point 20 from the vertical plane 39.

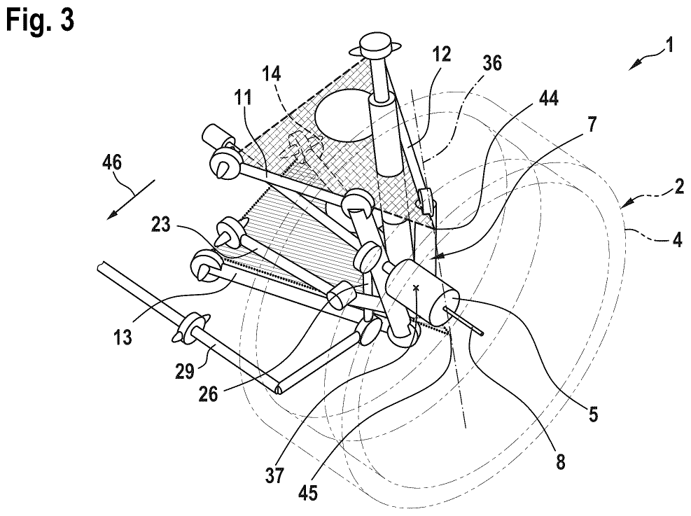

FIG. 3 shows a further schematic representation of the wheel suspension 1. It can be seen here that the longitudinal central axes 31 and 32 and the longitudinal central axes 33 and 34 of the chassis links 11 and 12 and of the chassis links 13 and 14 respectively meet at an intersection point 44 and 45 respectively. The two intersections 44 and 45 lie on the wheel support rotational axis 36 or define it. It can be seen that the wheel support rotational axis 36 lies below the horizontal plane 38 extending through the wheel center 37 behind the horizontal plane 38 in the direction of travel and thus in the second orthant 41. The direction of travel of the motor vehicle is indicated by the arrow 46.

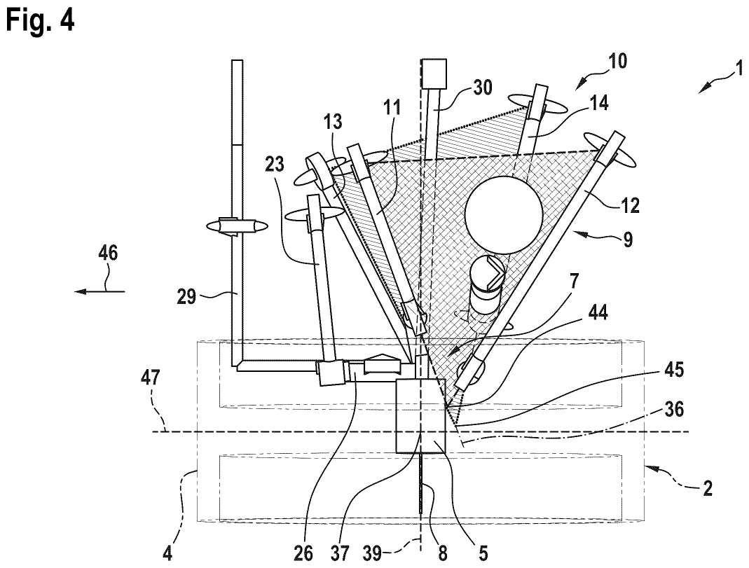

FIG. 4 is a schematic plan view of the wheel suspension 1 in a first view. In addition to the vertical plane 39, a wheel center plane 47 is now shown which is perpendicular to the vertical plane 39 and receives the wheel center 37. It becomes clear that intersections of the longitudinal center axes 31, 32, 33 and 34 of the chassis links 11, 12, 13 and 14 intersect the wheel center plane 47 in the direction of travel behind the vertical plane 39, that is to say in the second orthant 41 and/or the third orthant 42. As a result, a wheel support rotational axis 36 is achieved, which is almost perpendicular to the ground or to the roadway, provided that the motor vehicle is arranged as intended. Furthermore, it can be clearly seen that the first kinematic points 15 and 19 of the chassis links 11 and 13, that is to say the front chassis links, lie close to the vertical plane 39, in any case closer than the kinematic points 17 and 21 of the chassis links 12 and 14, that is to say the rear chassis links.

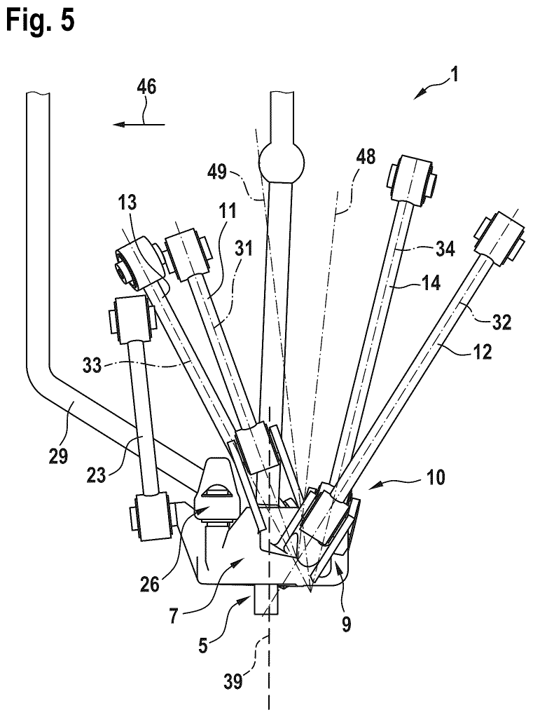

FIG. 5 is a schematic plan view of the wheel suspension 1 in a second view. The longitudinal central axes 31, 32, 33 and 34 of the chassis links 11, 12, 13 and 14 each intersect the vertical plane 39, viewed in plan view, at a sweep angle. The mean sweep angles of the link assemblies 9 and 10 result from the mean value of the sweep angles of the respective chassis links 11 and 12 and 13 and 14, respectively. For the first link assembly 9, the mean sweep angle is indicated by the angle bisector 48 and for the second guide rod arrangement 10 by the second bisector 49. It can be seen that the mean sweep angles have different signs with respect to the vertical plane 39. In addition, the second kinematic points 16, 20 and 25 lie in front of the vertical plane 39 in the direction of travel, and the second kinematic points 18 and 22 lie behind the vertical plane 39 in the direction of travel.

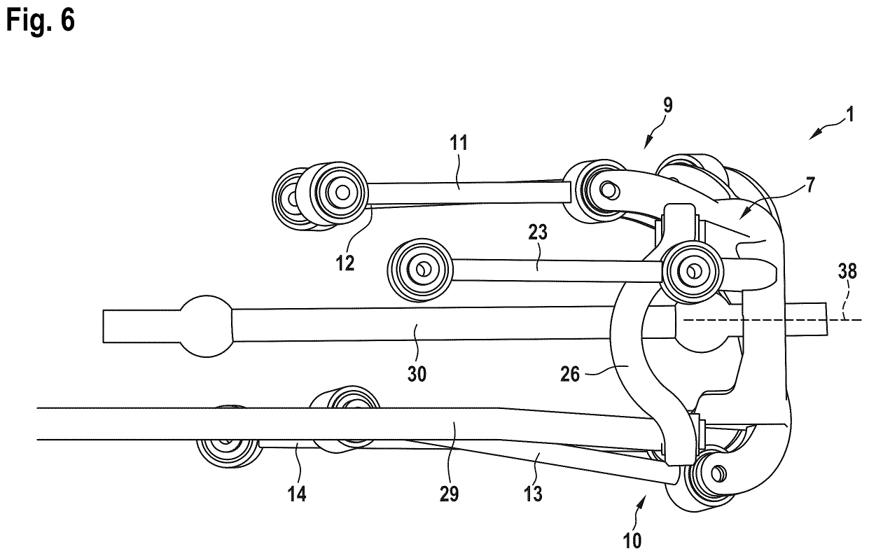

FIG. 6 shows a schematic side view of the wheel suspension 1. It can be seen that all the kinematic points 19, 20, 21 and 22 of the chassis links 13 and 14 of the second link assembly 10 lie below the wheel center 37 or below the horizontal plane 38. In addition, they are arranged below the kinematic points 24 and 25 of the track rod 23 or below the entire track rod 23.

The described wheel suspension 1 is of particularly compact construction and, in addition, a wheel 2 suspended with it can be driven in an advantageous manner with an electric traction machine. It should be expressly pointed out that in the exemplary embodiment some or even all of the features explained in the description are shown in combination with one another. However, the wheel suspension 1 can of course also be realized in other embodiments with which the described advantages are achieved, which have only some of the features.

### LIST OF REFERENCE NUMERALS

1 wheel suspension
2 wheel
3 rim
4 tire
5 wheel hub
6 wheel bearing
7 wheel support
8 wheel hub rotational axis
9 1st link assembly
10 2nd link assembly
11 1st chassis link
12 2nd chassis link
13 1st chassis link
14 2nd chassis link
15 1st kinematic point of the first chassis link of the first link assembly
16 2nd kinematic point of the first chassis link of the first link assembly
17 1st kinematic point of the second chassis link of the first link assembly
18 2nd kinematic point of the second chassis link of the first link assembly
19 1st kinematic point of the first chassis link of the second link assembly
20 2nd kinematic point of the first chassis link of the second link assembly
21 1st kinematic point of the second chassis link of the second link assembly
22 2nd kinematic point of the second chassis link of the second link assembly
23 track rod
24 1st track rod kinematic point
25 2nd track rod kinematic point
26 coupling rod
27 1st coupling rod kinematic point
28 2nd coupling rod kinematic point
29 stabilizer
30 drive shaft
31 longitudinal center axis
32 longitudinal center axis
33 longitudinal center axis
34 longitudinal center axis
35 longitudinal center axis
36 wheel support rotational axis
37 wheel center
38 horizontal plane
39 vertical plane
40 1st orthant
41 2nd orthant
42 3rd orthant
43 4th orthant
44 intersection
45 intersection
46 arrow
47 wheel center plane
48 bisector
49 bisector

1-10. (canceled)

11. A wheel suspension for a motor vehicle, comprising: a wheel support on which a wheel hub is rotatably supported or can be rotatably supported about a wheel hub rotational axis by a wheel bearing, and comprising two chassis links of a first link assembly, two chassis links of a second link assembly and a track rod which is hinged to a track rod kinematic point on the wheel support, wherein the chassis links are hinged to the wheel support in such a way that the wheel support describes a rotational movement about a virtual wheel support rotational axis, when the track rod is displaced, and wherein a horizontal plane which receives the wheel center and which is aligned horizontally and a vertical plane which receives the wheel center and which is perpendicular to the horizontal plane delimit multiple orthants from one another, wherein in the installed position of the wheel suspension the track rod kinematic point is arranged in a first orthant of the orthants, wherein the wheel support rotational axis runs through a second orthant of the orthants opposite the first orthant with respect to the wheel hub rotational axis.

12. The wheel suspension according to claim 11, wherein a wheel center plane receiving the wheel center is arranged in the axial direction with respect to the wheel hub rotational axis in the center of a wheel which is fastened or can be fastened to the wheel hub, wherein each of the chassis links has a longitudinal center axis intersecting the wheel center plane in the second orthant or in a third of the orthants present on the same side of the vertical plane.

13. The wheel suspension according to claim 11, wherein the chassis links are each hinged to the wheel support via a first kinematic point, wherein the first kinematic points of the chassis links of the first link assembly are located in the first orthant and/or in the third orthant, and/or in that the first kinematic points of the chassis links of the second link assembly are located in the second orthant and/or a fourth orthant of the orthants arranged on the same side of the horizontal plane.

14. The wheel suspension according to claim 11, wherein the chassis links are respectively hinged or can be hinged via a second kinematic point to a body or to an auxiliary frame which is connected or can be connected to the body, wherein the second kinematic points of the chassis link of the first link assembly are located in the first orthant and/or the third orthant and/or the second kinematic points of the chassis links of the second link assembly are located in the second orthant and/or the fourth orthant.

15. The wheel suspension according to claim 11, wherein a first of the chassis links of the first link assembly and a first of the chassis links of the second link assembly are arranged in such a way that their second kinematic points are arranged in the first orthant and/or the fourth orthant, and/or in that a second of the chassis links of the first link assembly and a second of the chassis links of the second link assembly are arranged in such a way that their second kinematic points are arranged in the second orthant and/or the third orthant.

16. The wheel suspension according to claim 11, wherein the chassis links intersect the vertical plane in each case at an sweep angle, wherein a mean sweep angle of the chassis links of the first link assembly and a mean sweep angle of the chassis links of the second link assembly have different signs.

17. The wheel suspension according to claim 11, wherein the track rod has on its side facing away from the track rod kinematic point a further track rod kinematic point which has a distance from the vertical plane which is at least 80% and at most 120% of a distance between the vertical plane and the second kinematic point of the first chassis link of the second link assembly.

18. The wheel suspension according to claim 11, wherein a distance between the kinematic points of the first chassis link of the first link assembly and/or a distance between the track rod kinematic points of the track rod is at least 50% and/or at most 75% of the distance between the kinematic points of the second chassis link of the first link assembly and/or of the distance between the kinematic points of the second chassis link of the second link assembly.

19. The wheel suspension according to claim 11, wherein the first kinematic point of the first chassis link of the first link assembly and/or the first kinematic point of the first chassis link of the second link assembly have a distance from the vertical plane which is smaller than a distance of the first kinematic point of the second chassis link of the first link assembly from the vertical plane and/or as a distance of the first kinematic point of the second chassis link of the second link assembly from the vertical plane.

20. A motor vehicle having a wheel suspension, in particular a wheel suspension according to claim 11, wherein the wheel suspension comprises a wheel support on which a wheel hub is rotatably supported or can be rotatably supported about a wheel hub rotational axis by a wheel bearing, and two chassis links of a first link assembly, two chassis links of a second link assembly and a track rod which is hinged to a track rod kinematic point on the wheel support, wherein the chassis links are hinged to the wheel support in such a way that the wheel support describes a rotational movement about a virtual wheel support rotational axis, when the track rod is displaced, and wherein a horizontal plane which receives the wheel center and which is aligned horizontally and a vertical plane which receives the wheel center and which is perpendicular to the horizontal plane delimit multiple orthants from one another, wherein in the installed position of the wheel suspension the track rod kinematic point is arranged in a first orthant of the orthants, wherein the wheel support rotational axis runs through a second orthant of the orthants opposite the first orthant with respect to the wheel hub rotational axis.

21. The wheel suspension according to claim 12, wherein the chassis links are each hinged to the wheel support via a first kinematic point, wherein the first kinematic points of the chassis links of the first link assembly are located in the first orthant and/or in the third orthant, and/or in that the first kinematic points of the chassis links of the second link assembly are located in the second orthant and/or a fourth orthant of the orthants arranged on the same side of the horizontal plane.

22. The wheel suspension according to claim 12, wherein the chassis links are respectively hinged or can be hinged via a second kinematic point to a body or to an auxiliary frame which is connected or can be connected to the body, wherein the second kinematic points of the chassis links of the first link assembly are located in the first orthant and/or the third orthant and/or the second kinematic points of the chassis links of the second link assembly are located in the second orthant and/or the fourth orthant.

23. The wheel suspension according to claim 13, wherein the chassis links are respectively hinged or can be hinged via a second kinematic point to a body or to an auxiliary frame which is connected or can be connected to the body, wherein the second kinematic points of the chassis links of the first link assembly are located in the first orthant and/or the third orthant and/or the second kinematic points of the chassis links of the second link assembly are located in the second orthant and/or the fourth orthant.

24. The wheel suspension according to claim 12, wherein a first of the chassis links of the first link assembly and a first of the chassis links of the second link assembly are arranged in such a way that their second kinematic points are arranged in the first orthant and/or the fourth orthant, and/or in that a second of the chassis links of the first link assembly and a second of the chassis links of the second link assembly are arranged in such a way that their second kinematic points are arranged in the second orthant and/or the third orthant.

25. The wheel suspension according to claim 13, wherein a first of the chassis links of the first link assembly and a first of the chassis links of the second link assembly are arranged in such a way that their second kinematic points are arranged in the first orthant and/or the fourth orthant, and/or in that a second of the chassis links of the first link assembly and a second of the chassis links of the second link assembly are arranged in such a way that their second kinematic points are arranged in the second orthant and/or the third orthant.

26. The wheel suspension according to claim 14, wherein a first of the chassis links of the first link assembly and a first of the chassis links of the second link assembly are arranged in such a way that their second kinematic points are arranged in the first orthant and/or the fourth orthant, and/or in that a second of the chassis links of the first link assembly and a second of the chassis links of the second link assembly are arranged in such a way that their second kinematic points are arranged in the second orthant and/or the third orthant.

27. The wheel suspension according to claim 12, wherein the chassis links intersect the vertical plane in each case at an sweep angle, wherein a mean sweep angle of the chassis links of the first link assembly and a mean sweep angle of the chassis links of the second link assembly have different signs.

28. The wheel suspension according to claim 13, wherein the chassis links intersect the vertical plane in each case at an sweep angle, wherein a mean sweep angle of the chassis links of the first link assembly and a mean sweep angle of the chassis links of the second link assembly have different signs.

29. The wheel suspension according to claim 14, wherein the chassis links intersect the vertical plane in each case at an sweep angle, wherein a mean sweep angle of the chassis links of the first link assembly and a mean sweep angle of the chassis links of the second link assembly have different signs.

30. The wheel suspension according to claim 15, wherein the chassis links intersect the vertical plane in each case at an sweep angle, wherein a mean sweep angle of the chassis links of the first link assembly and a mean sweep angle of the chassis links of the second link assembly have different signs.
